(19) United States
(12) Patent Application Publication
(10) Pub. No.: US 2012/0221621 A1
(43) Pub. Date: Aug. 30, 2012

(54) DISTRIBUTED SYSTEM, COMMUNICATION MEANS SELECTION METHOD, AND COMMUNICATION MEANS SELECTION PROGRAM

(76) Inventor: Tomoyoshi Sugawara, Minato-ku (JP)

(21) Appl. No.: 13/501,835

(22) PCT Filed: Oct. 12, 2010
(86) PCT No.: PCT/JP2010/006057

§ 371 Date: May 14, 2012

(30) Foreign Application Priority Data
Oct. 15, 2009 (JP) 2009-238611

(51) Int. Cl. G06F 15/16

(52) U.S. Cl. 709/201

(57) ABSTRACT

There is provided a distributed system including multiple nodes, each node including multiple communication means, the distributed system characterized by including: storage means for storing physical location information on anode and identification information on an application running on the node in association with each other; communication means determination means which, when an application running on a first node communicates with an application running on a second node, extracts location information on the first node and the second node from the storage means based on identification information on the applications, and determines optimum communication means from the multiple communication means based on the extracted location information; and communication means selection means for selecting communication means based on the determination result made by the communication means determination means.

### TECHNICAL FIELD

The present invention relates to a distributed system including multiple nodes. The present invention also relates to a communication means selection method and a communication means selection program for selecting communication means in a distributed system including multiple nodes.

### BACKGROUND ART

There are various forms of distributed systems, such as a cluster having multiple computation nodes (hereinafter, nodes) in a single housing, a data center having multiple nodes or clusters in one building, and a widely distributed system in which nodes, clusters, and data centers are interconnected through a wide area network. Further, part of nodes in a distributed system may be configured as a virtual machine (VM), rather than a physical machine, derived from one node divided by virtual software, or as a partition derived from one node divided by hardware. In such a distributed system, user programs (hereinafter called applications) running on nodes communicate with each other to perform processing.

Like a wide variety of nodes in a distributed system, communication means between nodes are of great variety. For example, there are message communications such as TCP/IP in a common Ethernet (Registered Trademark) architecture, Remote Direct Memory Access (RDMA) provided in a network for clusters such as InfiniBand, and communications using a shared memory between partitions. Since these communication means have respective characteristics, a programmer who develops applications generally selects and uses appropriate communication means (in terms of high performance, high reliability, low power consumption, etc.) from communication means provided by the distributed system. However, it is difficult for the programmer developing applications to select appropriate communication means at all times. For example, when the message communication, RDMA, and the shared memory communication are available, the communication speed becomes faster in the following order: shared memory>RDMA>message communication. However, since the message communication such as that using sockets is widely used, many programmers use the message communication in the event.

Therefore, communication means selection methods are designed to select appropriate communication means in a lower layer such as a communication library or an operating system (hereinafter, OS). Examples of related communication means selection systems are disclosed in Patent Literature (PTL) 1 and Patent Literature (PTL) 2.

PTL 1 discloses a radio communication system for switching over between communication means depending on the size. The invention disclosed in PTL 1 is a radio communication system for selecting one kind of transmission path from among plural kinds of transmission paths as a transmission path for radio communication between opposed first and second radio stations to perform radio communication. Each of the first and second radio stations has data analyzing means for analyzing at least the characteristics and volume of data input from a data terminal connected and to be sent, transmission path selecting means for selecting one kind of transmission path from among plural kinds of transmission paths based on the analysis result by the data analyzing means, and communication means for performing radio communication using the one kind of transmission path selected by the transmission path selecting means. This invention enables a radio station on the sending side to select an optimal transmission path from among plural kinds of transmission paths based on the data characteristics and the volume of data to be sent to perform radio communication. Further, one kind of usable transmission path is selected from among the plural kinds of transmission paths not only based on the result of analysis by the data analyzing means for analyzing the characteristics and volume of data to be sent, but depending also on speed information, the received electric field intensity, position information, and the traffic situation, so that the optimum transmission path can be selected not only based on the data characteristics and data size, but also in consideration of the usage, the radio wave receiving environment, and the like.

PTL 2 discloses a communication device for switching over between communication paths based on the application characteristics (IP address, port, etc.). The communication device according to the invention as set forth in PTL 2 is connectable to multiple networks using a wide variety of communication methods. This communication device includes a communication application for performing communications, network selection means for selecting an optimum network the communication content of the communication application, an application characteristic database for storing the characteristics of the communication application, and communication content learning means for leaning the communication content of the communication application and updating the application characteristic database based on the learning results. In other words, this communication device dynamically changes a route determination method depending on the application used, the status of a service, and the operational history so that the optimum network can be automatically selected at any time.

### CITATION LIST

### Patent Literatures

PTL 1: Japanese Patent Application Publication No. 2004-343456 (Paragraphs 0007-0008, and 0016)
PTL 2: Japanese Patent Application Publication No. 2007-282142 (Paragraphs 0014 and 0017)

### SUMMARY OF INVENTION

### Technical Problem

However, even if the method disclosed in each of the above-mentioned methods is used, commonly-used communication path selection means cannot select an optimum communication path based on the physical arrangement of applications communicating with each other.

The reason is that one application cannot determine the physical arrangement between its correspondent and its own because the application identifies the correspondent using a logical identifier such as an IP address to communicate therewith. For example, when multiple applications are running in different partitions on the same server and start communication with each other in such a situation that these applications know only each other's IP addresses, these applications are likely to communicate with each other using message communication despite communication within the same server. If both become aware of being located in different partitions on the same server before the start of communication, these applications can perform communication using a shared memory.

Therefore, it is an object of the present invention to provide a communication means selection method and a communication means selection program capable of optimizing communication between applications in a distributed system. It is another object of the present invention to provide a distributed system to which a communication means selection method capable of optimizing communication between applications is applied.

### Solution to Problem

The distributed system according to the present invention is a distributed system including multiple nodes, each node including multiple communication means, the distributed system characterized by including: storage means for storing physical location information on a node and identification information on an application running on the node in association with each other; communication means determination means which, when an application running on a first node communicates with an application running on a second node, extracts location information on the first node and the second node from the storage means based on identification information on the applications, and determines optimum communication means from the multiple communication means based on the extracted location information; and communication means selection means for selecting communication means based on the determination result made by the communication means determination means.

The communication means selection method according to the present invention is a communication means selection method for selecting communication means in a distributed system including multiple nodes, characterized by including: storing physical location information on a node and identification information on an application running on the node in association with each other; when an application running on a first node communicates with an application running on a second node, extracting location information on the first node and the second node based on identification information on the applications, and determining optimum communication means from multiple communication means based on the extracted location information; and selecting communication means based on the determination result.

The communication means selection program according to the present invention is a communication means selection program for selecting communication means in a distributed system including multiple nodes, characterized by causing a computer to perform the following, wherein physical location information on a node and identification information on an application running on the node are stored on the computer in association with each other: communication means determination processing for extracting location information on a first node and a second node based on identification information on applications when an application running on the first node communicates with an application running on the second node, and determining optimum communication means from multiple communication means based on the extracted location information; and communication means selection processing for selecting communication means based on the determination result.

### Advantageous Effect of Invention

According to the present invention, communication between applications can be optimized in a distributed system.

### BRIEF DESCRIPTION OF DRAWINGS

FIG. 1 is a block diagram showing a configuration example of a first embodiment of a distributed system according to the present invention.

FIG. 2 is a flowchart showing an operation example of the distributed system in the first embodiment.

FIG. 3 is a block diagram showing a configuration example of a second embodiment of the distributed system according to the present invention.

FIG. 4 is a flowchart showing an operation example of the distributed system in the second embodiment.

FIG. 5 is a diagram showing the configuration of a specific example of a distributed system according to the present invention.

FIG. 6 is an explanatory drawing showing a specific example of an allocation information file.

FIG. 7 is an explanatory drawing showing routing information on a machine 100.

FIG. 8 is a diagram showing the operation of a specific second example of a distributed system according to the present invention.

FIG. 9 is a block diagram showing an example of the minimum configuration of the distributed system according to the present invention.

### DESCRIPTION OF EMBODIMENTS

### Exemplary Embodiment 1

### First Embodiment

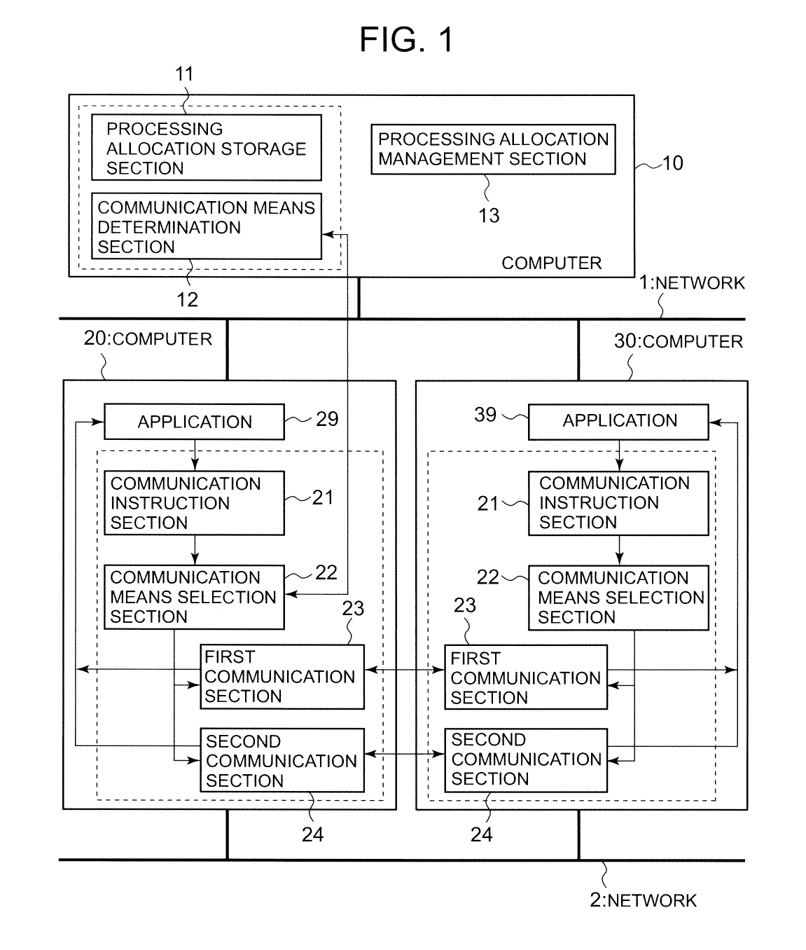

Exemplary embodiments of the present invention will now be described with reference to the accompanying drawings. Referring to FIG. 1, a distributed system according to a first embodiment of the present invention includes a computer 10, a computer 20, and a computer 30, all of which work according to programs. Among those, the computer 10, the computer 20, and the computer 30 are interconnected through a network 1. Further, at least the computer 20 and the computer 30 are interconnected through a network 2. The computer 10 includes a task allocation storage section 11, a communication means determination section 12, and a task allocation management section 13. The computer 20 and the computer 30 include a communication instruction section 21, a communication means selection section 22, a first communication section 23, and a second communication section 24, respectively. Processes according to an application 29 are executed on the computer 20, while processes according to an application 39 are executed on the computer 30.

Specifically, the task allocation management section 13 is implemented by a CPU of an information processing apparatus working according to a program. The task allocation management section 13 has a function to manage starting/quitting/moving of applications. For example, a function, such as remote shell as the rsh command of UNIX (Registered Trademark), job dispatcher, or a virtual machine management tool, corresponds to the function provided in the task allocation management section 13. Upon startup of an application, the task allocation management section 13 specifies the name of the application program and the name of a destination computer on which the program will be started. Further, when the application is moved to another computer, the task allocation management section 13 specifies the name of application program and the name of a destination computer.

Specifically, the task allocation storage section 11 is implemented by a storage device, such as a memory, a magnetic disk drive, or an optical disk drive. The allocation storage section 11 stores a pair of a logical identifier of the application and a physical location identifier of the computer based on information when the task allocation management section 13 has allocated (started/moved) the application. The logical identifier of the application is used to identify a correspondent upon communication between applications. As the logical identifier of the application, for example, there is a pair of the IP address of a destination computer on which the application will be started and a port number used by the application. Instead of the logical identifier of this application, a logical identifier of the computer may be specified. As the logical identifier of the computer, a host name or an IP address can be used. On the other hand, the physical location identifiers of computers indicate a physical location relationship between the computers. As the physical location identifier, of a computer, for example, there is a housing number. In this embodiment, it is assumed that computers located in the same housing can use shared memory communication.

Specifically, the communication means determination section 12 is implemented by a CPU and a network interface section in an information processing apparatus working according to a program. The communication means determination section 12 has the function of receiving a communication means determination request from the communication means selection section 22 to request it to determine communication means, and determining appropriate communication means by a method to be described below. Here, the communication means determination request includes at least logical identifiers of communication source and correspondent applications. The communication means determination section 12 uses the logical identifiers as keys to search the task allocation storage section 11 in order to extract the physical location identifiers of computers on which the communication source and correspondent applications run. Further, the communication means determination section 12 compares the extracted two physical location identifiers, determines optimum communication means, and sends the determination result back to the communication means selection section 22. For example, when the housing numbers match, the communication means determination section 12 sends back a value representing “shared memory communication” as the determination result, while when they do not match, it sends back a value representing “message communication” as the determination result. In the embodiment, it is assumed that communication means include not only communication between terminals through a network but also shared memory communication for exchanging data through the same memory in the same hardware.

Specifically, the communication instruction section 21 is implemented by the CPU of the information processing apparatus working according to a program. When a request to send is output from the application 29, the communication instruction section 21 outputs it to the communication means selection section 22. The request to send includes at least the logical identifier of the communication source (requesting) application, the logical identifier of a correspondent application, and a send data body. As the function corresponding to the function provided by the communication instruction section 21, for example, there is the UNIX send system call or MPI (Message Passing Interface) MPI_send.

Specifically, the communication means selection section 22 is implemented by the CPU and a network interface section in an information processing apparatus working according to a program. The communication means selection section 22 has the function of extracting the logical identifiers of communication source and correspondent applications from the request to send output from the communication instruction section 21, creating a communication means determination request, and sending it to the communication means determination section 12. The communication means selection section 22 may also extract the logical identifiers of computers from the logical identifier of the communication source and correspondent applications included in the request to send to create the communication means determination request. The communication means selection section 22 also has the function of receiving the determination result from the communication means determination section 12, and selecting either the first communication section or the second communication section based on the determination result. For example, when the determination result is a value representing “message communication,” the communication means selection section 22 selects the first communication section, while when the determination result is a value representing “shared memory communication,” it selects the second communication section.

The first communication section 23 sends and receives data rough the network 1. For example, when the network 1 is the Ethernet, the first communication section performs TCP/IP communication. On the other hand, the second communication section 24 sends and receives data through the network 2. For example, when the network 2 is Interconnect within the housing, the second communication section performs shared memory communication.

The application 29 and the application 39 are the source application and the destination application to perform predetermined processing, respectively, while communicating with each other.

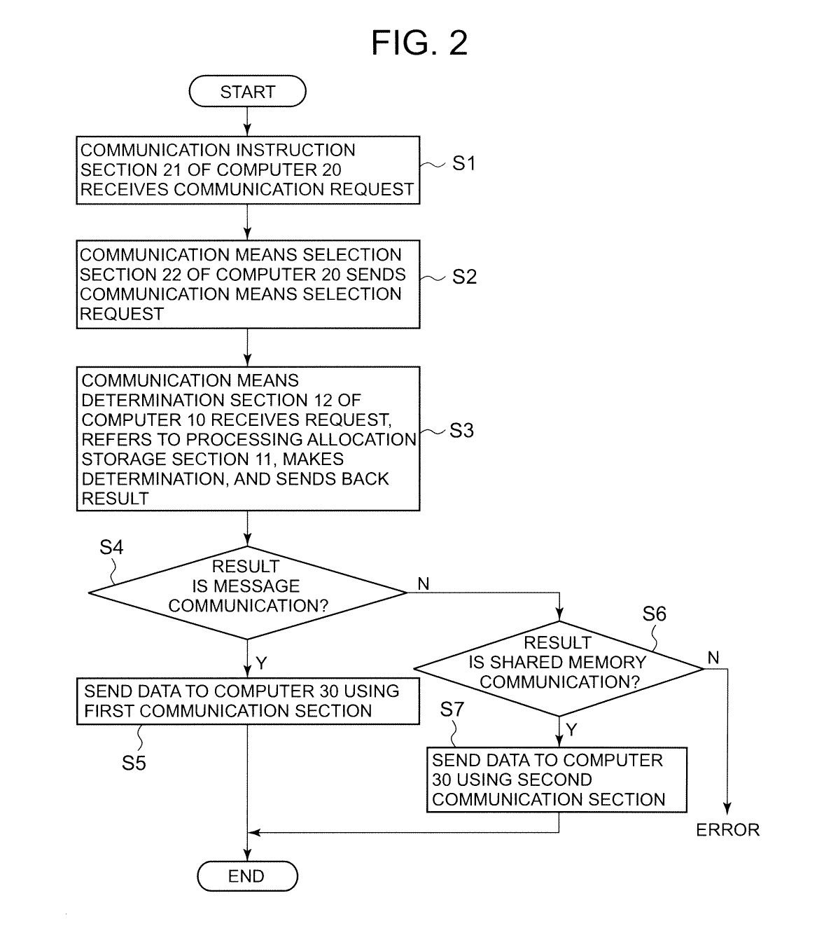

Referring next to FIG. 1 and a flowchart of FIG. 2, the overall operation of the embodiment will be described.

When the application 29 of the computer 20 outputs a communication request to the communication instruction section 21, the communication instruction section 21 outputs, to the communication means selection section 22, the communication request output from the application 29 (step S1). Here, in the request to send, at least the logical identifier of the application 29 as the communication source, the logical identifier of the application 39 as the correspondent, and the send data body are included.

Next, based on the communication request output from the communication instruction section 21, the communication means selection section 22 of the computer 20 generates a communication means selection request, and sends the generated communication means selection request to the communication means determination section 12 of the computer 10 (step S2). Specifically, the communication means selection section 22 extracts, from the request to send output from the communication instruction section 21, the logical identifier of the application 29 as the communication source and the logical identifier of the application 39 as the correspondent. Then, the communication means selection section 22 uses the extracted logical identifiers to generate a communication means determination request and send it to the communication means determination section 12.

Next, the communication means determination section 12 of the computer 10 receives the communication means selection request and refers to the task allocation storage section 11 to determine communication means. Then, the communication means determination section 12 sends the determination result back to the communication means selection section 22 of the computer 20 (step S3). Specifically, the communication means determination section 12 extracts the logical identifiers of the communication source and correspondent applications from the communication means selection request received. Then, the communication means determination section 12 searches the task allocation storage section 11 using the extracted logical identifiers as keys to extract computers on which the communication source and correspondent applications run. Then, the communication means determination section 12 compares the extracted two physical location identifiers, determines optimum communication means, and sends the determination result back to the communication means selection section 22. For example, when the housing numbers match, the communication means determination section 12 sends back the value representing “shared memory communication” as the determination result, while when they do not match, it sends back the value representing “message communication” as the determination result. Thus, based on the information stored in the task allocation storage section 11, the communication means determination section 12 converts the logical identifiers of the processing entities of the communication source and communication destination included in the communication means determination request into physical location information, and based on the converted physical location information, it selects the fastest communication means and sends back the selected communication means as the communication means determination result.

Next, based on the determination result received from the communication means determination section 12, the communication means selection section 22 of the computer 20 selects communication means (step S4).

When the determination result is the value representing “message communication” (Y in step S4), the computer 20 uses the first communication section 23 to send data to the computer 30 (step S5).

When the determination result is the value representing “shared memory communication” (Y in step S6), the computer 20 uses the second communication section 24 to send data to the computer 30 (step S7).

When the determination result is neither “message communication” nor “shared memory communication” (for example, when the determination was not able to be made for some reason, such as that corresponding physical locations are not registered), the communication means selection section 22 outputs error information.

Next, the effect of the embodiment will be described.

In the embodiment, relationships between the logical identifiers of applications and physical location information on nodes (computers) are stored. Then, when applications communicate, physical location information on nodes on which applications related to communication run is identified from the logical identifiers of the applications related to communication to select the fastest communication means available between these nodes. Thus, the embodiment has the effect of being able to select the fastest communication means as communication means between applications in a distributed system based on the positional relationship between nodes on which the applications run when multiple communication means are selectively usable.

### Exemplary Embodiment 2

### Second Embodiment

Next, a second embodiment of a distributed system according to the present invention will be described. The distributed system according to the second embodiment includes a determination result storage section in addition to the configuration of the first embodiment. The following will describe this embodiment with reference to the accompanying drawings.

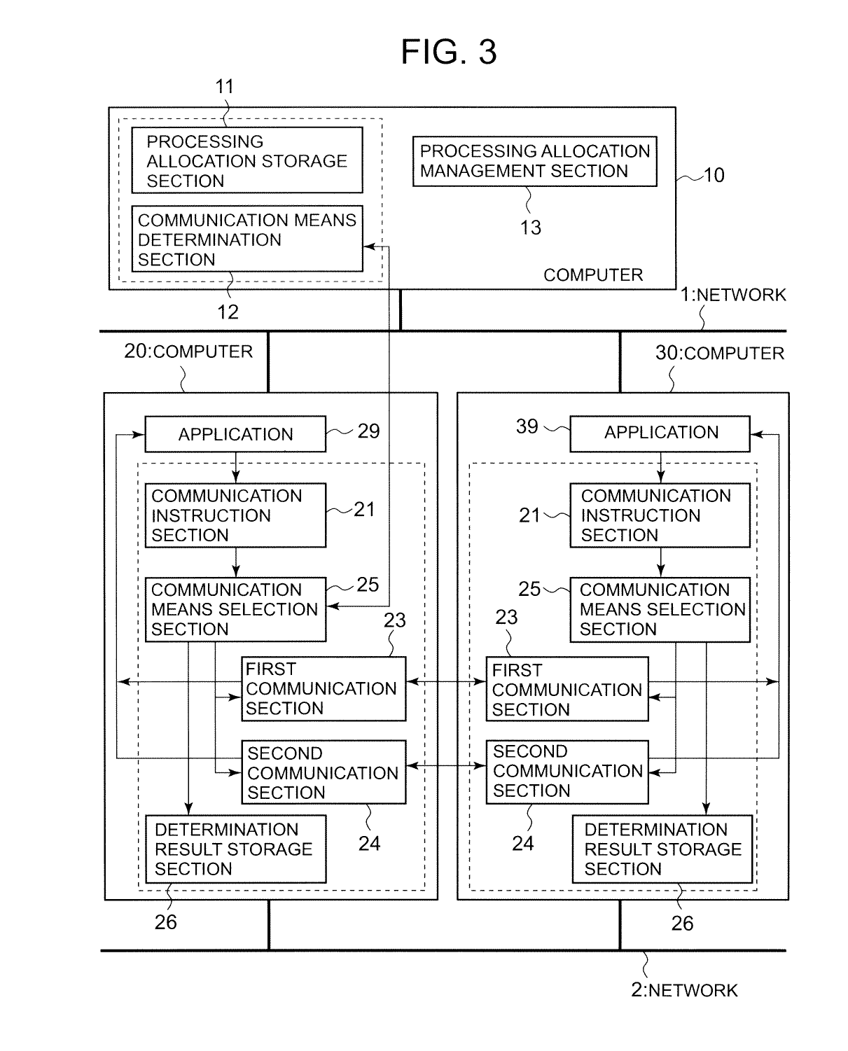

Referring to FIG. 3, the distributed system in the second embodiment of the present invention includes the computer 10, the computer 20, and the computer 30 like in the first embodiment. The computer 10, the computer 20, and the computer 30 are interconnected through the network 1 in the same way. Further, at least the computer 20 and the computer 30 are interconnected through the network 2. The computer 10 includes the communication means determination section 12 and the task allocation management section 13 as well. In addition, the computer 10 includes a task allocation storage section 14. Then, like in the first embodiment, the computer 20 and the computer 30 both include the communication instruction section 21, the first communication section 23, and the second communication section 24. In addition, they include a communication means selection section 25 (in the embodiment, the communication means selection section 25 is included instead of the communication means selection section 22 shown in the first embodiment) and a determination result storage section 26. Then, the applications are also the same as those in the first embodiment in that the application 29 runs on the computer 20 and the application 39 runs on the computer 30.

The communication means determination section 12 and the task allocation management section 13 are the same as those in the first embodiment. In other words, the communication means determination section 12 receives a communication means determination request from the communication means selection section 22 and searches the task allocation storage section 14 using, as keys, logical identifiers of applications included in the communication means determination request. Then, the communication means determination section 12 extracts the physical location identifiers of computers on which communication source and correspondent applications run, compares the extracted two physical location identifiers to determine optimum communication means, and sends the determination result back to the communication means selection section 22. The task allocation management section 13 manages starting/quitting/moving of the applications.

The task allocation storage section 14 stores a pair of the logical identifier of an application and the physical location identifier of a computer based on information when the task allocation management section 13 has allocated (started/moved) the application. In addition to the same configuration as the first embodiment, the task allocation storage section 14 in this embodiment also has a function to request the determination result storage section 26 of the computer 20 to delete a corresponding storage portion when the task allocation management section 13 moves/shuts down the application. This delete request includes at least the logical identifier of the moved/shut down application. Specifically, in this embodiment, the task allocation storage section 14 is implemented by the CPU of the information processing apparatus working with a storage device, such as an optical disk drive or a magnetic disk drive, according to a program.

The communication instruction section 21, the first communication section 23, and the second communication section 24 are also the same as those in the first embodiment. In other words, when a request to send is output from the application 29, the communication instruction section 21 outputs it to the communication means selection section 25. The first communication section 23 and the second communication section 24 send and receive data through the network 1 and the network 2, respectively.

The communication means selection section 25 extracts the logical identifiers of communication source and correspondent applications from the request to send output from the communication instruction section 21, creates a communication means determination request using the extracted logical identifiers, and sends it to the communication means determination section 12. Further, the communication means selection section 25 receives a determination result from the communication means determination section 12, and selects either the first communication section 23 or the second communication section 24 based on the determination result. In addition to the same configuration as the first embodiment, the communication means selection section 25 in this embodiment also has a function to store, in the determination result storage section 26, the determination result received from the communication means determination section 12. Stored in the determination result storage section 26 by the communication means selection section 25 are the logical identifiers of the communication source and correspondent applications and the determination result. Further, the communication means selection section 25 has a function to search the determination result storage section 26 using, as keys, the logical identifiers of the communication source and correspondent applications extracted from the request to send or the logical identifier of computers extracted therefrom. In addition, the communication means selection section 25 has the function of selecting either the first communication section 23 or the second communication section 24 based on the determination result included when corresponding entries are found.

Specifically, the determination result storage section 26 is implemented by a storage device such as a magnetic disk drive or an optical disk drive. The determination result storage section 26 stores the determination result made by the communication means determination section 12. The determination result storage section 26 also stores the logical identifiers of the communication source and correspondent applications in association with the determination result.

Like in the first embodiment, the application 29 and the application 39 are a communication source application and a destination application, respectively, which perform predetermined processing while communicating with each other.

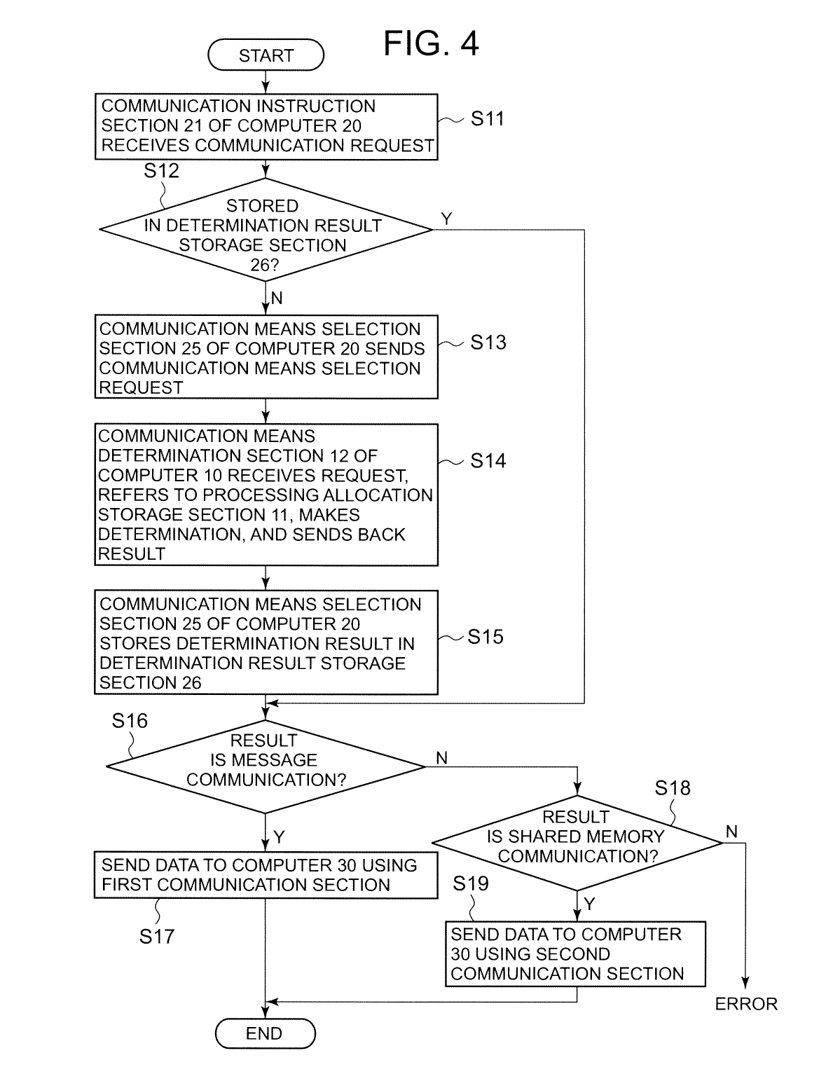

Referring next to FIG. 3 and a flowchart of FIG. 4, the overall operation of the embodiment will be described.

When the application 29 of the computer 20 outputs a communication request to the communication instruction section 21, the communication instruction section 21 outputs, to the communication means selection section 25, the communication request output from the application 29 (step S11). Here, in the request to send, at least the logical identifier of the application 29 as the communication source, the logical identifier of the application 39 as the correspondent, and the send data body are included.

Next, the communication means selection section 25 of the computer 20 extracts the logical identifiers of the source and correspondent applications from the communication request output from the communication instruction section 21. Then, the communication means selection section 25 of the computer 20 searches the determination result storage section 26 using, as keys, the logical identifiers of the applications extracted from the communication request to determine whether there is a determination result (step S12). In other words, the communication means selection section 25 determines whether a determination result of optimum communication means between the applications identified by the extracted logical identifiers has already been stored in the determination result storage section 26. For example, the communication means selection section 25 determines whether a determination result corresponding to the identifiers included in the communication request has been already stored.

When it is determined that a determination result already exists, the communication means selection section 25 proceeds to processing step S16 (Y in step S12). On the other hand, when it is determined that no determination result exists, the communication means selection section 25 proceeds to processing step S13 (N in step S12).

When it is determined in step S12 that there is no determination result, the communication means selection section 25 of the computer 20 uses the extracted logical identifiers of the applications to generate a communication means selection request, and send the generated communication means selection request to the communication means determination section 12 of the computer 10 (step S13).

When receiving the communication means selection request from the communication means selection section 25, the communication means determination section 12 of the computer 10 refers to the task allocation storage section 11 to determine communication means. Then, the communication means determination section 12 sends the determination result back to the communication means selection section 25 of the computer 20 (step S14). Specifically, the communication means determination section 12 extracts the logical identifiers of the source and correspondent applications from the communication means selection request received. Then, the communication means determination section 12 searches the task allocation storage section 14 using the extracted logical identifiers as keys to extract the physical location identifiers of computers on which the communication source and correspondent applications run. Then, the communication means determination section 12 compares the extracted two physical location identifiers, determines optimum communication means, and sends the determination result back to the communication means selection section 25.

Next, the communication means selection section 25 of the computer 20 stores, in the determination result storage section 26, the received determination result together with the logical identifiers of the applications (step S15).

When it is determined in step S12 that there is a determination result, or when the received determination result is stored in step S15 in the determination result storage section 26, the communication means selection section 25 of the computer 20 selects communication means based on the determination result (step S16). Specifically, in step S16, the communication means selection section 25 determines whether the determination result is “message communication.”

When it is determined in step S16 that the determination result is the value representing “message communication” (Y in step S16), the computer 20 uses the first communication section to send data to the computer 30 (step S17). On the other hand, when it is determined that the determination result is not the value representing “message communication” (N in step S16), the communication means selection section 25 determines whether the determination result is “shared memory communication” (step S18).

When it is determined in step S18 that the determination result is the value representing “shared memory communication” (Y in step S18), the computer 20 uses the second communication section to send data to the computer 30 (step S19).

When the determination result is neither “message communication” nor “shared memory communication” (N in step S18), the communication means selection section 25 outputs error information.

Next, the effects of the embodiment will be described.

Like in the first embodiment, relationships between the logical identifiers of applications and physical location information on nodes (computers) are stored in this embodiment. Then, when applications communicate, physical location information on nodes on which applications related to communication run is identified from the logical identifiers of the applications related to communication to select the fastest communication means available between these nodes. Thus, the embodiment has the effect of being able to select the fastest communication means as communication means between applications in a distributed system based on the positional relationship between nodes on which the applications run when multiple communication means are selectively usable.

Further, in the embodiment, the communication means selection section 25 stores, in the determination result storage section 26, the determination result sent back from the communication means determination section 12. Then, the communication means selection section 25 refers to the determination result storage section 26 to select communication means. If the same determination has been already made, the previous determination result will be reused to select communication means without performing wasteful processing redundantly. Thus, the embodiment has the effect of being able to reduce communications between the communication means selection section 25 and the communication means determination section 12 each time one node communicate with another.

In the first embodiment and the second embodiment, the description is made in connection with the case where the computer 10, the computer 20, and the computer 30 are connected to the network 1, separately. However, for example, the computer 10 and the computer 20, or the computer 10 and the computer 30 may be implemented as one computer.

Further, each computer shown in the first embodiment and the second embodiment is not merely denoted as a computer having a physical housing. For example, it may also include a hardware partition or a VM.

In addition, although the first embodiment and the second embodiment show a configuration having two kinds of communication sections, namely the first communication section and the second communication section, a configuration having three or more kinds of communication sections can also be provided. In this case, the number of conditional branches for the communication means selection section 22 and the communication means selection section 25 to select a third communication section and the like is increased.

### Example 1

Next, the operation of the present invention will be described using specific examples. First, an example of applying the present invention to a distributed system composed of multiple computers loaded with Linux (Registered Trademark) will be illustrated.

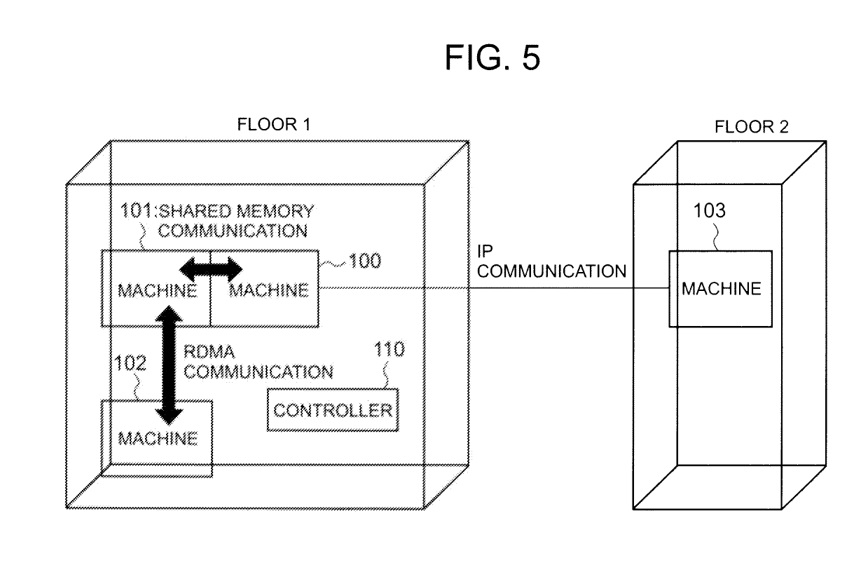

FIG. 5 is a diagram showing a configuration of a specific example of a distributed system according to the present invention. In FIG. 5, machine 100 to machine 103 and a controller 110 are all computer loaded with Linux.

The machine 100 and the machine 101 are components obtained by dividing the hardware of a computer in one housing into two partitions. The machine 102 is placed in the same room as the machine 100 and the machine 101. The machine 103 is placed in a location some distance away from the machine 100, the machine 101, and the machine 102, e.g., on another floor in the same building. Further, three kinds of communication hardware components, namely Ethernet, InfiniBand, and Interconnect, are loaded into the machine 100 and the machine 101. The Ethernet and InfiniBand are loaded into the machine 102. The Ethernet is loaded into the machine 103. The three kinds of hardware components are implemented as Linux devices with device names “eth0,” “inf0,” and “icon0,” respectively.

The controller 110 is placed in a location capable of performing IP communication with the machine 100 to machine 103. The controller 110 is set as at least a default gateway of the machine 100.

In this distributed system, communication means can be selected according to the following rules:

In the case of the same housing, IP communication using the Ethernet, RDMA communication using InfiniBand, or shared memory communication using Interconnect can be selected.

In the case of different housings in the same room, IP communication using the Ethernet or RDMA communication using InfiniBand can be selected.

In the case of different housings in different rooms, IP communication using the Ethernet can be selected.

The communication speed is in the following order: IP communication using the Ethernet<RDMA communication using InfiniBand<shared memory communication using Interconnect. In the embodiment, fast communication means is selected as much as possible.

The present invention can be applied to this distributed system in a way to be described below.

In the example, the task allocation storage section 11 and the task allocation management section 13 of the computer 10 in the first and second embodiments are implemented as a distributed shell and an allocation information file on the controller 110. Further, the communication means determination section 12 is implemented as a server process on the controller 110. Here, the distributed shell uses a remote execution command (rsh, ssh, or the like) to run an application on a remote computer. When succeeding in remotely starting the application, the distributed shell further acquires the housing number, the room number, and the like from a remote computer's configuration file or the like, and stores them in combination with the IP address of the remote computer.

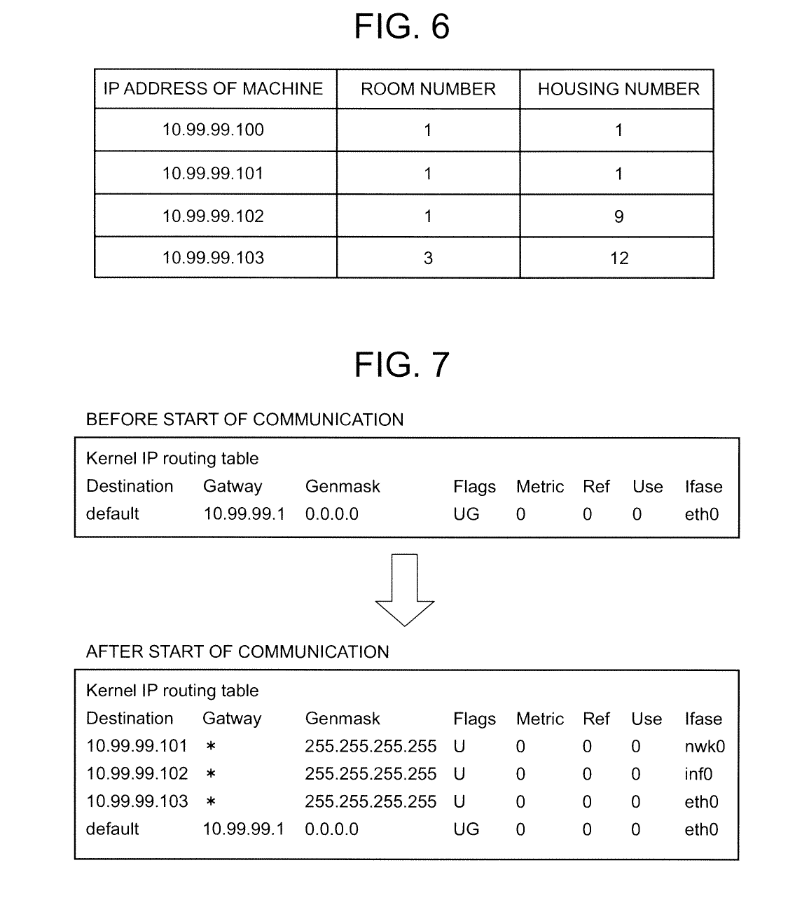

As an example, FIG. 6 shows the content of an allocation information file after applications are started on the machine 100 to machine 103. Here, the association between computers and IP addresses is assumed as follows: 10.99.99.100 for the machine 100, 10.99.99.101 for the machine 101, 10.99.99.102 for the machine 102, and 10.99.99.103 for the machine 103.

The communication instruction section 21, the communication means selection section 22, the first communication section 23, and the second communication section 24 are all implemented as some functions of the operating system (OS) and communication hardware on the machine 100 to machine 103.

When the machine 100 communicates with the machine 101, an application on the machine 100 outputs a send system call destined to the machine 101. Then, the application on the machine 100 outputs an IP address of the destination and data body to the OS on the machine 100. At this point, since the machine 100 has no settings of routing to the machine 101, the machine 100 sends a first packet to the controller 110 as a default gateway. Since this packet is sent in IP communication, it includes the IP address of a source (machine 100) and the IP address of a destination (machine 101).

Next, the controller 110 extracts the IP address of the machine 100 and the IP address of the machine 101 from the received packet. Then, the controller 110 uses the extracted IP addresses as keys to search for the housing number and the room number of each machine, respectively, in order to select appropriate communication means from these numbers according to the above-mentioned rules. In this example, it is found that the room number is 1 and the housing number is 1 from the IP address 10.99.99.100 of the machine 100, and the room number is 1 and the housing number is 1 from the IP address 10.99.99.101 of the machine 101. Since this corresponds to the case of “the same housing,” the controller 110 selects “shared memory communication” with the maximum communication speed.

Next, the controller 110 executes a remote command to pass this determination result to the machine 100 in order to change the route settings by the machine 100. Specifically, the controller 110 executes the following command: “rsh 10.99.99.100 route add 10.99.99.101 dev nwk0.” In this command, the second-half portion “route add 10.99.99.101 dev nwk0” sets up routing information indicating “packets to be sent to 10.99.99.101 are sent using device “nwk0”.”

After the routing information is set, the machine 100 sends packets to the machine 101 via “nwk0,” i.e., in shared memory communication using Interconnect.

The same processing is performed when communication is started from the machine 100 to the machine 102 and when communicating is started from the machine 100 to the machine 103. Then, the routing information on the machine 100 is finally updated to enable the machine 100 to perform communication using the fastest communication hardware, respectively. FIG. 7 shows routing information (output of route commands) on the machine 100 before the start of communication and after the start of communication.

Thus, in this example, the fastest communication means can be selected as communication means between applications in a distributed system based on a positional relationship between nodes on which the applications run.

In this example, Linux is employed as the OS, but any OS other than Linux can also be implemented in the same manner as this example as long as the function of setting routing information is included.

### Example 2

Next, the operation of the present invention will be described using a second example. Here, an example of applying the present invention to a distributed system including a network switch called a “programmable flow switch” and a virtual machine is shown.

The “programmable flow switch” is a switch separated into a switch section for actually processing a flow and a controller (control server) for giving instruction to the switch section on how to process the flow. In the flow switch, a flow of packets in the switch can be directly controlled. In other words, based on the IP addresses of communication source/destination of a packet, the type of packet, and the like, the flow switch uses information called a flow table to perform control on to what number of a network port the packet is to be output. The “programmable flow switch” is designed to separate the network switch into a switch body and the controller on an interface for setting the flow table. NEC announced a prototype of the programmable flow switch in October, 2008.

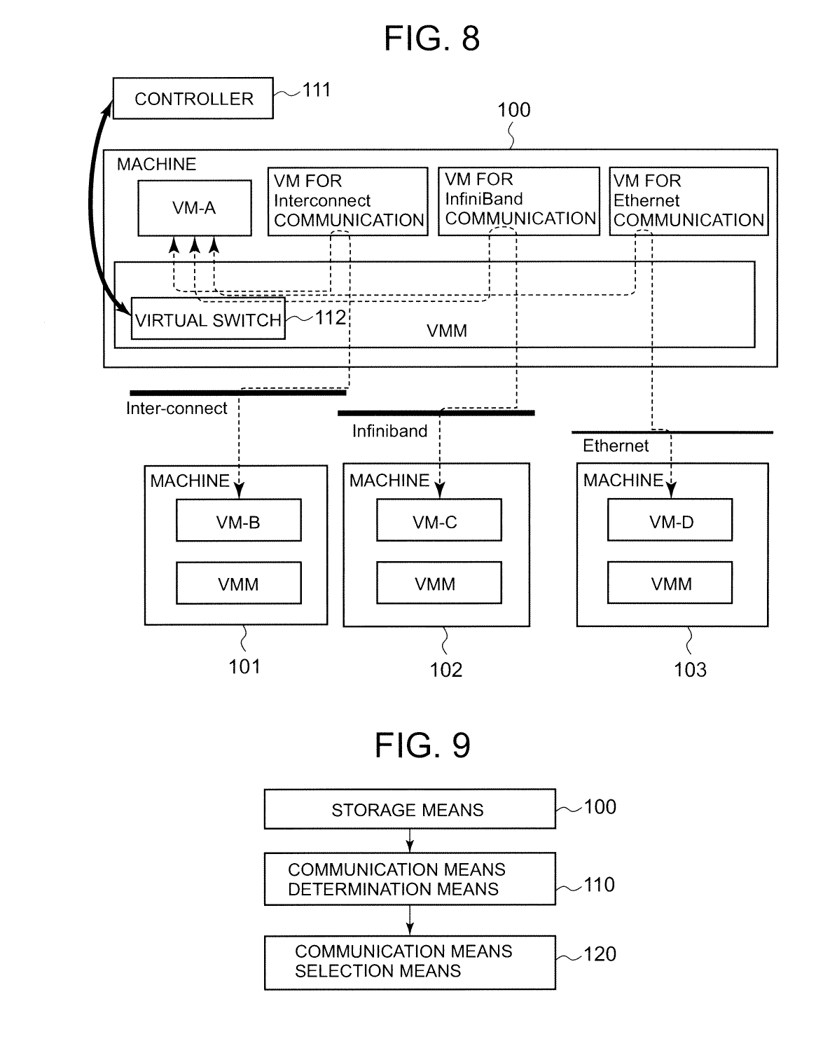

FIG. 8 shows an example of the configuration of a distributed system in which the programmable flow switch is combined with a virtual machine. In the example shown in FIG. 8, the programmable flow switch is implemented as a virtual switch 112 in a virtual machine monitor (VMM).

In this example, the configuration of a computer is the same as that in the first example. In other words, as shown in FIG. 7, the machine 100 and the machine 101 are components obtained by dividing the hardware of a computer in one housing into two partitions. The machine 102 is placed in the same room as the machine 100 and the machine 101. The machine 103 is placed in a location some distance away from the machine 100, the machine 101, and the machine 102, e.g., on another floor in the same building. Further, three kinds of communication hardware components, namely Ethernet, InfiniBand, and Interconnect, are loaded into the machine 100 and the machine 101. The Ethernet and InfiniBand are loaded into the machine 102. The Ethernet is loaded into the machine 103.

In the example, a VMM is further loaded into each machine on which a virtual machine (VM) runs. It is assumed that VM-A runs on the machine 100, VM-B runs on the machine 101, VM-C runs on the machine 102, and VM-D runs on the machine 103.

Further, a management VM for each communication hardware component runs on the VMM of each computer. In other words, a VM for Ethernet communication, a VM for InfiniBand, and a VM for Interconnect run. These VMs have a function (I/O virtualization feature) to virtualize one communication hardware component as if multiple hardware components existed for normal VMs on which applications run.

The controller 11 is placed in a location capable of performing IP communication with the VM-A, the VM-B, the VM-C, and the VM-D. Further, the controller 111 is configured as a default gateway to the VM-A.

In this example, the task allocation storage section 11 and the task allocation management section 13 of the computer 10 in the first and second embodiments are implemented as a VM management console and a VM allocation information file on the controller 111. The communication means determination section 12 is implemented as a server process on the controller 111. Here, the VM management console uses VM control commands to start, quit, and move the VM. When succeeding in starting the VM, the VM management console stores the housing number, the room number, and the like in combination with the IP address of the VM.

The communication instruction section 21 and the communication means selection section 22 are implemented as part of the functions of the virtual switch 112. The first communication section 23 and the second communication section 24 are implemented as a VM for communication hardware and part of the functions of the communication hardware.

When the VM-A communicates with the VM-B, an application on the VM-A outputs an IP packet destined to the VM-B through the OS. Then, the application on the VM-A outputs the IP packet to the virtual switch 112. At this point, the virtual switch 112 has no flow settings for communication from the VM-A to the VM-B. Therefore, the programmable flow switch uses its basic function to defer forwarding of the first packet and send part of the packet to the controller 111. This packet includes the IP address of a source (VM-A) and the IP address of a destination (VM-B).

The controller 111 extracts the IP address of the VM-A and the IP address of the VM-B from the received packet, and uses these as keys to search for the housing numbers and the room numbers of machines on which the respective VMs run. Then, the controller 111 selects appropriate communication means, i.e., a communication VM from these numbers according to the same rules as in the first example. In this example, the controller 111 selects the “VM for Interconnect.”

Next, based on this determination result, the controller 111 sends flow setting information back to the virtual switch 112 to send the VM for Interconnect communication packets from the VM-A to the VM-B. Next, based on the flow setting information received, the virtual switch 112 sets up a flow table.

After the flow table is set, the VM-A sends packets to the VM-B in shared memory communication using Interconnect via the VM for Interconnect communication.

Thus, in this example, the fastest communication means can be selected as communication means between applications in a distributed system based on a positional relationship between nodes on which the applications run.

From the points described above, it can be said that the present invention relates to a communication means selection method and a communication means selection program, which cooperate with processing allocation management means for allocating or moving processing (process, task, virtual machine) on computers constituting a distributed system to optimize communication between applications, and a distributed system including them.

Further, it can be said that the present invention includes the following means:

The present invention is a distributed system characterized in that, among nodes constituting the distributed system, at least one first node has a task allocation storage section and a communication means determination section, and at least one second node has a communication instruction section, a communication means selection section, and two or more kinds of communication sections. In this distributed system, the task allocation storage section of the first node obtains, from the task allocation management section, physical location information on nodes on which processing entities such as applications or VMs run, and stores the physical location information in the task allocation storage section. On the other hand, when the communication instruction section is called in order for a processing entity being executed on a second node to communicate with a processing entity on a third node different from the second node, the communication means selection section sends a communication means determination request to the communication means determination section of the first node.

In response to receipt of the communication means determination request, the communication means determination section of the first node converts, based on the information stored in the task allocation storage section, the logical identifiers of the processing entities of a communication source and a communication destination included in the communication means determination request into physical location information indicative of the physical locations of nodes. Further, based on the converted physical location information, the communication means determination section selects the fastest communication means and sends the communication means determination result back to the second node. In response to receipt the communication means determination result, the communication means selection section calls a communication section for providing the determined communication means to perform communication.

Further, a determination result storage section is included in the second node to store the communication means determination result so that, when a corresponding determination result is found as a result of referring to the determination result storage section before the communication means determination request is sent to the communication means determination section of the first node, the communication means selection section selects communication means based on the determination result.

It can be seen from the above that the present invention has the following effect.

The effect of the present invention is that, when multiple communication means are selectively usable, the fastest communication means can be selected as communication means between applications in a distributed system based on a positional relationship between nodes on which the applications run. The reason is that the present invention is configured to store a relationship between the logical identifier of an application and physical location information on a node, and when the application starts communication, identify physical location information on nodes, on which applications related to communication run, from the logical identifiers of the applications related to communication, and select the fastest communication means available between these nodes.

Next, the minimum configuration of a distributed system according to the present invention will be described. FIG. 9 is a block diagram showing an example of the minimum configuration of the distributed system. As shown in FIG. 9, the distributed system includes, as the minimum number of components, storage means 100, communication means determination means 110, and communication means selection means 120.

In the distributed system having the minimum configuration shown in FIG. 9, the storage means 100 stores physical location information on a node including multiple communication means and identification information on an application running on the node in association with each other. Then, when an application running on a first node communicates with an application running on a second node, the communication means determination means 110 extracts location information on the first node and the second node from the storage means 100 based on the application identification information and determines optimum communication means from multiple communication means based on the extracted location information. Next, based on the determination result by the communication means determination means 110, the communication means selection means 120 selects communication means.

Thus, according to the distributed system having the minimum configuration, communication means is selected based on physical location information on nodes to enable optimization of communication between applications.

Note that, in the exemplary embodiments, characteristic configurations of distributed systems as shown in the following (1) to (5) are illustrated:

(1) A distributed system including multiple nodes, each node including multiple communication means, the distributed system characterized by including: storage means (for example, implemented by the task allocation storage section 11 and the task allocation management section 13) for storing physical location information on a node and identification information on an application running on the node in association with each other; communication means determination means (for example, implemented by the communication means determination section 12) which, when an application (for example, implemented by the application 29) running on a first node (for example, the computer 20) communicates with an application (for example, implemented by the application 39) running on a second node (for example, implemented by the computer 30), extracts location information on the first node and the second node from the storage means based on identification information on the applications, and determines optimum communication means from the multiple communication means based on the extracted location information; and communication means selection means (for example, implemented by the communication means selection section 22) for selecting communication means based on the determination result made by the communication means determination means.

(2) The distributed system may be configured to further including determination result storage means (for example, implemented by the determination result storage section 26) for storing the optimum communication means between the applications determined by the communication means determination means, wherein the communication means selection means refers to the determination result storage means before sending a determination request to the communication means determination means, and when a determination result corresponding to the determination request is stored, the communication means selection means selects communication means based on the stored determination result.

(3) The distributed system may be configured to further include a communication means determination device, wherein the communication means determination device includes storage means and communication means determination means, each node includes communication means selection means, and the communication means selection means selects communication means based on a determination result made by the communication means determination means and received from the communication means determination device.

(4) The distributed system may be configured such that, among nodes constituting the distributed system, a first node (for example, implemented by the computer 10) includes processing allocation/storage means (for example, implemented by the task allocation storage section 11) and communication means determination means (for example, implemented by the communication means determination section 12), and a second node (for example, implemented by the computer 20) includes communication instruction means (for example, implemented by the communication instruction section 21), communication means selection means (for example, implemented by the communication means selection section 22), and two or more kinds of communication means (for example, implemented by the first communication section and the second communication section), wherein the processing allocation/storage means of the first node stores physical location information indicative of the physical location of a node on which a processing entity (for example, the application 29) runs, and when the communication instruction means is called in order for a processing entity being executed on the second node to communicate with a processing entity (for example, the application 39) on a third node (for example, implemented by the computer 30) different from the second node, the communication means selection means sends the communication means determination means of the first node a communication means determination request to make a request for the determination of optimum communication means, and when receiving the communication means determination request, the communication means determination means of the first node converts the logical identifiers of the processing entities of the communication source and the communication destination included in the communication means determination request into physical location information based on information stored in the processing allocation/storage means, selects the fastest communication means based on the converted physical location information, and sends the selected communication means back to the second node as a communication means determination result, and when receiving the communication means determination result from the communication means determination section of the first node, the communication means selection section performs communication using the communication means indicated in the communication means determination result.

(5) The distributed system may be configured such that the second node includes determination result storage means (for example, implemented by the determination result storage section 26) for storing the communication means determination result, and the communication means selection means refers to the determination result storage means before sending a communication means determination request to the communication means determination means of the first node, and when a determination result corresponding to the communication means determination request is stored, the communication means selection means selects communication means based on the stored determination result.

As described above, although the present invention is described with reference to the exemplary embodiments and examples, the present invention is not limited to the aforementioned exemplary embodiments and examples. Various changes that can be understood by those skilled in the art within the scope of the present invention can be made to the configurations and details of the present invention.

This application claims priority based on Japanese Patent Application No. 2009-238611, filed on Oct. 15, 2009, the entire disclosure of which is incorporated herein by reference.

### INDUSTRIAL APPLICABILITY

The present invention can be applied to IT/NW integrated management products used at data centers.

1. A distributed system including a plurality of nodes, each node including a plurality of communication means, the distributed system characterized by comprising:
a storage unit for storing physical location information on a node and identification information on an application running on the node in association with each other;
a communication means determination unit which, when an application running on a first node communicates with an application running on a second node, extracts location information on the first node and the second node from the storage unit based on identification information on the applications, and determines optimum communication means from the plurality of communication means based on the extracted location information; and
a communication means selection unit for selecting communication means based on the determination result made by the communication means determination unit.

2. The distributed system according to claim 1, further comprising
a determination result storage unit for storing the optimum communication means between the applications determined by the communication means determination unit,
wherein the communication means selection unit refers to the determination result storage unit before sending a determination request to the communication means determination unit, and when a determination result corresponding to the determination request is stored, the communication means selection unit selects communication means based on the stored determination result.

3. The distributed system according to claim 1, further comprising
a communication means determination device,
wherein the communication means determination device includes a storage unit and a communication means determination unit,
each node includes a communication means selection unit, and
the communication means selection unit selects communication means based on a determination result made by the communication means determination unit and received from the communication means determination device.

4. A distributed system characterized in that
among nodes constituting the distributed system, a first node includes a processing allocation/storage unit and a communication means determination unit, and a second node includes a communication instruction unit, a communication means selection unit, and two or more kinds of communication means,
the processing allocation/storage unit of the first node stores physical location information indicative of a physical location of a node on which a processing entity runs,
when the communication instruction unit is called in order for a processing entity being executed on the second node to communicate with a processing entity on a third node different from the second node, the communication means selection unit sends the communication means determination unit of the first node a communication means determination request to make a request for a determination of optimum communication means,
when receiving the communication means determination request, the communication means determination unit of the first node converts logical identifiers of processing entities of a communication source and a communication destination included in the communication means determination request into physical location information based on information stored in the processing allocation/storage unit, selects fastest communication means based on the converted physical location information, and sends the selected communication means back to the second node as a communication means determination result, and
when receiving the communication means determination result from the communication means determination unit of the first node, the communication means selection unit performs the communication using the communication means indicated in the communication means determination result.

5. The distributed system according to claim 4, wherein
the second node includes a determination result storage unit for storing the communication means determination result, and
the communication means selection unit refers to the determination result storage unit before sending a communication means determination request to the communication means determination unit of the first node, and when a determination result corresponding to the communication means determination request is stored, the communication means selection unit selects communication means based on the stored determination result.

6. A communication means selection method for selecting communication means in a distributed system including a plurality of nodes, characterized by comprising:
storing physical location information on a node and identification information on an application running on the node in association with each other;
when an application running on a first node communicates with an application running on a second node, extracting location information on the first node and the second node based on identification information on the applications, and determining optimum communication means from a plurality of communication means based on the extracted location information; and
selecting communication means based on the determination result.

7. The communication means selection method according to claim 6, further comprising:
storing the determined optimum communication means between the applications; and
when a determination result corresponding to a determination request is stored before the determination request is sent, selecting communication means based on the stored determination result.

8. A computer readable information recording medium storing a communication means selection program for selecting communication means in a distributed system including a plurality of nodes, characterized by causing a computer to perform the following, wherein physical location information on a node and identification information on an application running on the node are stored on the computer in association with each other:
communication means determination processing for extracting location information on a first node and a second node based on identification information on applications when an application running on the first node communicates with an application running on the second node, and determining optimum communication means from a plurality of communication means based on the extracted location information; and
communication means selection processing for selecting communication means based on the determination result.

9. The computer readable information recording medium storing the communication means selection program according to claim 8, causing a computer to perform the following, wherein the optimum communication means between the applications determined in the communication means determination processing is stored on the computer,
when a determination result corresponding to a determination request is stored before the determination request is sent to the communication means determination processing in the communication means selection processing, processing for selecting communication means based on the stored determination result.
